(19) United States
(12) Patent Application Publication
(10) Pub. No.: US 2012/0111017 A1
(43) Pub. Date: May 10, 2012

(54) PARTICULATE DEFLAGRATION TURBOJET

(76) Inventor: Donald Keith Fritts, Broken Arrow, OK (US)

(21) Appl. No.: 12/943,262

(22) Filed: Nov. 10, 2010

(51) Int. Cl. F02C 3/26

(52) U.S. Cl. 60/772; 60/39.464

(57) ABSTRACT

A turbine engine, such as for example a jet engine or turbojet, that is fueled by particulate fuel, such as cornstarch or other similar particulate products, that burn under deflagration conditions. The engine is modified from a standard engine in that the dry inlet air is compressed before being premixed with the particulate fuel in a pre-deflagration mixing chamber located immediately upstream of the burners. The mixed fuel is then burned in the deflagration burners to provide turning force for the turbines of the turbine engine.

### BACKGROUND OF THE INVENTION

1. Field of the Invention

The present invention is a turbine engine such as a jet turbine engine or turbojet that is fueled by particulate fuel, such as cornstarch or other natural products, that burn under deflagration conditions.

2. Description of the Related Art

It is long been known that dust can be a very volatile material under the proper conditions. The National Fire Protection Agency has established a volatility value to most common dusts in the form of a Kst (deflagration index for dusts)(bar-m-/sec) rating. If methane is compared to cornstarch under detonation conditions, the cornstarch produces 3 times the energy force of the methane gas per volume. It has been long recognized that solid fuels are a more effective fuel source than gas, which is why rockets are powered by solid fuel cells.

There are four factors that are needed to produce an explosion, whether in the combustion chamber of an engine or any other enclosure. They are fuel source, oxidant, containment and ignition source. In a simple combustion engine, the fuel source is vaporized liquid gasoline, the oxidant is air and ignition source is a spark plug. The displacement wall of the turbine or jet housing creates an enclosure which produces the necessary containment.

The jet or turbine engine only requires the fuel source to produce the necessary energy to drive the shaft work force requirements. The fuel burns fully and will not coat the moving parts. Using certain dusts results in a clean burning fuel that produces very high levels of energy. Among these natural dust or dust fuels would be cornstarch, soy flour, sucrose, coffee and wheat. Chemical dust such as ethylene diamine, ortazol, coal, charcoal and sodium lignosulfate would also be good fuel sources.

A standard jet or turbine engine would, of course, require modifications to use dust fuel and to overcome challenges of burning fuels that were not designed to burn. The first major challenge is the delivery system of the dust-air mixture to the combustion chamber. The second major challenge is to control the increased heating of the combustion chamber. Vaporized jet fuel provides cooling to the turbine during the injection process. To offset this cooling, the dust mixture should be delivered at a pressure of 5 psig or greater to the combustion chamber. This will cause a Joule Thompson refrigeration effect due to the pressure change from the storage system to the combustion chamber. Under normal conditions, the air to dust ratio would be 1 to 2 percent dust to 99 to 98 percent compressed air. The mixing system must be able to suspend the dust particles in the air mixture until it is delivered to the combustion chamber where it is initially ignited by an igniter. Testing has shown as soon as the burn temperature reaches approximately 300 degrees F., the fuel mixture goes into auto-ignition and does not require a separate ignition source since the flash point of most particulate matter is approximately 250 degrees F. During acceleration the dust-air ratio would increase to as much as 3 to 7 percent dust and 97 to 93 percent air. This makes this turbine very efficient. If this engine were at altitude the air ratio to fuel mixture would increase due to reduced air molecules, which would increase performance. This clean burning fuel would eliminate most waste from the engine exhaust.

Dust fuel is a truly renewable fuel source that requires very little refining and processing. The fuel is readily available and safe to store and transport because it is only volatile once the four elements required for detonation are present. The application of dust as a fuel source could be expanded to heating homes, producing electricity and space travel. The knowledge and technology is available now.

The term “detonation” is not what we are trying to achieve and is undesirable in a combustion engine. Detonation can cause major damage to an engine. The proper term for the method of combustion would be “deflagration” which is burning fuel at a rate below sonic velocity. By controlling the fuel mixture and limiting the size of the combustion chamber, detonation would be unlikely under normal conditions. It is also important to control the size of the dust particle to get uniform and clean burning. The smaller the dust particle, the faster the deflagration occurs.

### SUMMARY OF THE INVENTION

A standard jet or turbine engine would, of course, require modifications to use dust fuel and to overcome challenges of burning fuels that were not designed to burn. The first major challenge is the delivery system of the dust-air mixture to the combustion chamber. The second major challenge is to control the increased heating of the combustion chamber. Vaporized jet fuel provides cooling to the turbine during the injection process. To offset this cooling, the dust mixture should be delivered at a pressure of 5 psig or greater to the combustion chamber. This will cause a refrigeration effect due to the pressure change from the storage system to the combustion chamber. Under normal conditions, the air to dust ratio would be 1 to 2 percent dust to 99 to 98 percent compressed air. The mixing system must be able to suspend the dust particles in the air mixture until it is delivered to the combustion chamber where it is initially ignited by an igniter. Testing has shown as soon as the burn temperature reaches approximately 300 degrees F., the fuel mixture goes into auto-ignition and does not require a separate ignition source since the flash point of most particulate matter is approximately 250 degrees F. During acceleration the dust-air ratio would increase to as much as 3 to 7 percent dust and 97 to 93 percent air. This makes this turbine very efficient. If this engine were at altitude the air ratio to fuel mixture would increase due to reduced air molecules, which would increase performance. This clean burning fuel would eliminate most waste from the engine exhaust.

It is important in this engine to control the quality of the incoming air. If the air contains too much moisture the fuel mixture will burn too slowly or not at all and not produce the discharge energy required. By feeding the inlet air through desiccant dryers, the moisture level at a minimum level of −10 degrees pressure dew point can be maintained. FIG. 1 shows a desiccant chamber and a demisting pad. In aircraft applications this should provide the required pressure dew point while the aircraft is on the ground. A desiccant or other drying methods may be used to dry the air. If used in an aircraft, the air at higher altitudes is already very dry and might not need to be dried any further. On use with ground based turbines, compressed air compresses the water out of the air so a drying step for the air may not be needed. As altitude increases the press dew point drops and the ambient air would dry the desiccant chamber. A condensation port is located behind the high press compressor. The act of compressing the air inlet air causes condensation, which is trapped in the condensation chamber. The airflow around the condensation chamber will cause a slight vacuum, which will draw the condensation out of the turbine. The pre-deflagration mixing chamber is monitored with infrared sensor and dew point monitors. The fuel mixing fan causes the dust fuel to be suspended in the combustion air. The combination is then fed to the deflagration burners and a pre-determined flow rate. As output demand increases the deflagration burners are fed a greater volume of fuel mixture. The spool up time for the turbine should be less than if the turbine were burning “Jet A” fuel due to the increased lower flammable limit or LFL of dust. This will decrease the stall recovery time and decrease the rolling distance for takeoffs.

### BRIEF DESCRIPTION OF THE DRAWINGS

FIG. 1 is deflagration turbojet constructed in accordance with a preferred embodiment of the present invention.

### DETAILED DESCRIPTION OF THE PREFERRED EMBODIMENT

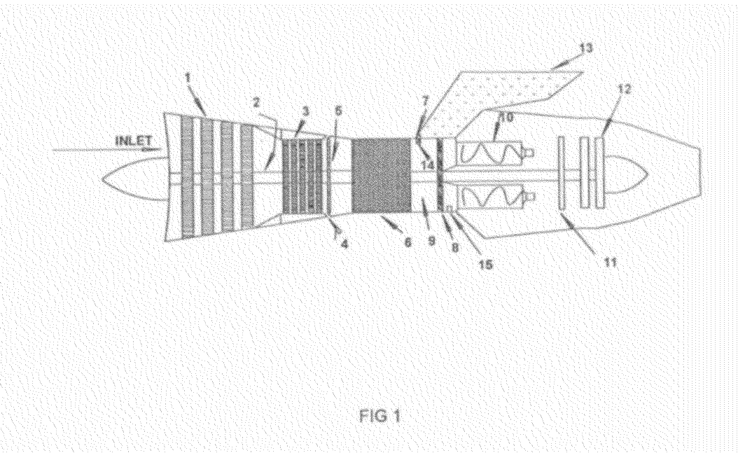

Referring now to FIG. 1, there is illustrated a deflagration turbojet constructed in accordance with a preferred embodiment of the present invention. The invention will hereafter be described in association with a jet aircraft engine, but the invention is not so limited and may be used in association with any type of jet engine.

This invention is modified from the configuration of a standard jet or turbine engine to allow the dust fuel to be burned. Specifically, the first major modification is in the delivery system of the dust-air mixture to the combustion chamber. The second major modification is to control the increased heating of the combustion chamber. Vaporized jet fuel provides cooling to the turbine during the injection process. To offset this cooling, the dust mixture should be delivered at a pressure of 5 psig or greater to the combustion chamber. This will cause a Joule Thompson effect or refrigeration effect due to the pressure change from the storage system to the combustion chamber. Under normal conditions, the air to dust ratio would be 1 to 2 percent dust to 99 to 98 percent compressed air. The mixing system must be able to suspend the dust particles in the air mixture until it is delivered to the combustion chamber where it is ignited by the igniter. During acceleration the dust-air ratio would increase to as much as 3 to 7 percent dust and 97 to 93 percent air. This makes this turbine very efficient. If this engine were at altitude the air ratio to fuel mixture would increase due to reduced air molecules, which would increase performance. This clean burning fuel would eliminate most waste from the engine exhaust.

Referring to FIG. 1, it is important in this engine to control the quality of the incoming air. If the air contains too much moisture the fuel mixture will burn too slowly or not at all and not produce the discharge energy required. By feeding the inlet air through desiccant dryers, the moisture level can be maintained at a minimum level of −10 degrees pressure dew point. The combustion air will enter the inlet and pass first through the low and high pressure compressors 1 and 3, respectively. Following the compressors 1 and 3, the compressed combustion air passes next through a demisting pad 5 and then into a desiccant chamber 6. The shaft 2 powers the compressors 1 and 3 and is powered by the high and low pressure turbines 11 and 12 of the engine.

In aircraft applications the demisting pad 5 and the desiccant chamber 6 should provide the required pressure dew point while the aircraft is on the ground. As altitude increases the pressure dew point drops and the ambient air would dry the desiccant chamber 6. A condensation port 4 is located in the condensation chamber which is located between the high pressure compressor 3 and the demister pad 5. The act of compressing the combustion air entering at the air inlet causes condensation which is trapped in the condensation chamber.

The airflow around the condensation chamber will cause a slight vacuum, which will draw the condensation out of the condensation chamber of the turbine via the condensation port 4. After passing through the desiccant chamber 6, the compressed and dried combustion air is ready for mixing with the particulate fuel in the pre-deflagration mixing chamber 9.

Fuel is fed from the fuel storage cell 13 into the pre-deflagration mixing chamber 9 via fuel inlet port 7 and mixing control valve 14. Under normal conditions, the air to dust ratio would be 1 to 2 percent dust to 99 to 98 percent compressed air. The mixing system must be able to suspend the dust particles in the air mixture until it is delivered to the combustion chamber or deflagration burners 10 where it is ignited by an igniter. During acceleration the dust-air ratio would increase to as much as 3 to 7 percent dust and 97 to 93 percent air. The pre-deflagration mixing chamber 9 is monitored with infrared sensors and dew point monitors 15 and this monitoring information is used to control the fuel mixture. The fuel mixing fan 8 causes the dust fuel to be suspended in the combustion air. The fuel and air combination or fuel mixture is then fed to the deflagration burners 10 at a pre-determined flow rate. As previously described, the dust fuel mixture should be delivered at a pressure of 5 psig or greater to the combustion chamber or deflagration burners 10 to provide cooling to the burners 10.

The hot gases from the burning fuel mixture at the deflagration burners 10 turn the high and low pressure turbines 11 and 12. As output demand increases the deflagration burners 10 are fed a greater volume of the fuel mixture. The spool up time for the turbines 11 and 12 should be less than if the turbines were burning “Jet A” fuel due to the increased lower flammable limit or LFL of dust. This will decrease the stall recovery time and decrease the rolling distance for takeoffs.

While the invention has been described in association with a jet aircraft engine, the invention is not so limited. The invention can be used in association with any type of turbine such as for example those used to drive electrical generators; pumps in cars, trucks, farm equipment and military vehicles; etc.

While the invention has been described with a certain degree of particularity, it is manifest that many changes may be made in the details of construction and the arrangement of components without departing from the spirit and scope of this disclosure. It is understood that the invention is not limited to the embodiments set forth herein for the purposes of exemplification, but is to be limited only by the scope of the attached claim or claims, including the full range of equivalency to which each element thereof is entitled.

What is claimed is:

1. A particulate deflagration turbine engine comprising:
a fuel cell connecting to and feeding particulate fuel to a mixing chamber of a turbine engine, said mixing chamber connected to and receiving dry compressed air from compressors provided on the turbine engine, said mixing chamber connected to and feeding a compressed air and particulate fuel mixture to at least one deflagration burner provided on the turbine engine, said at least one deflagration burner located adjacent to turbines of the turbine engine and burning the fuel mixture so as to provide turning force for the turbines.

2. A particulate deflagration turbine engine according to claim 1 wherein the compressed air is delivered to said mixing chamber at a pressure of at least 5 psig.

3. A particulate deflagration turbine engine according to claim 1 wherein the air to particulate fuel ratio of the fuel mixture ranges from 1-7% particulate fuel and from 99-93% air.

4. A particulate deflagration turbine engine according to claim 1 wherein the moisture content of the compressed air delivered to the mixing chamber is maintained at least at a level of −10 degrees pressure dew point.

5. A method for operating a particulate deflagration turbine engine comprising:
feeding particulate fuel from a fuel cell of a turbine engine to a mixing chamber of the turbine engine,
feeding dry compressed air from compressors on the turbine engine to a mixing chamber on the turbine engine where the dry compressed air is mixed with the particulate fuel to form a compressed air and particulate fuel mixture, and
feeding the fuel mixture to at least one deflagration burner provided on the turbine engine where the fuel mixture is burned under deflagration conditions to provide turning force for turbines on the turbine engine that are located adjacent to the burner.

6. A method for operating a particulate deflagration turbine engine according to claim 5 wherein the compressed air is delivered to said mixing chamber at a pressure of at least 5 psig.

7. A method for operating a particulate deflagration turbine engine according to claim 5 wherein the air to particulate fuel ratio of the fuel mixture ranges from 1-7% particulate fuel and from 99-93% air.

8. A method for operating a particulate deflagration turbine engine according to claim 1 wherein the moisture content of the compressed air delivered to the mixing chamber is maintained at least at a level of −10 degrees pressure dew point.
